(19) United States
(12) Patent Application Publication
(10) Pub. No.: US 2007/0154686 A1
(43) Pub. Date: Jul. 5, 2007

(54) Slat structure of a Venetian blind

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/320,813

(22) Filed: Dec. 30, 2005

(51) Int. Cl. B41M 5/00

(52) U.S. Cl. 428/195.1

(57) ABSTRACT

The present invention discloses a slat structure of a Venetian blind, which comprises a slat body and an ink layer on the surface of the slat body, wherein the slat body may be made of a PVC foam material or a foam material of mixed PVC and wood flour or any appropriate material, such as a composite material; the ink layer is printed on the surface of the slat body and may have lustrous finish and various colored patterns so that the entire Venetian blind may have colorful decoration to satisfy the customers.

### FIELD OF THE INVENTION

The present invention relates to a slat structure of a Venetian blind, particularly to a slat structure of a Venetian blind, whose surface various colorful patterns may be printed onto.

### BACKGROUND OF THE INVENTION

Generally speaking, the slats of a Venetian blind in markets are usually thin press-worked plastic blades, and the plastic blades are endowed with a color during the press-working process in order to provide a decoration effect. However, those plastic blades are usually only of a single color, or those plastic blades may also have a slowly-varying gradient of an identical color, but anyhow, those plastic blades are still of an identical color. Contrarily, the fabric curtain may have various colorful patterns and may also have glossy silk threads knitted inside in order to present a splendid effect. As the plastic Venetian blind is waterproof and anti-color fading, and also as the light passing therethrough is controllable, it is often used in a bathroom or a window where appropriate natural lighting is needed. Therefore, if the problem of lacking colorful patterns can be overcome, the marketability of Venetian blinds should be further promoted.

Accordingly, based on many years' experience of manufacturing and selling related products, and with persistent research and experiment, the Inventor has developed a highly marketable product of the present invention, which can overcome the problem of lacking colorful patterns of the conventional Venetian blinds.

### SUMMARY OF THE INVENTION

The primary objective of the present invention is to provide a slat structure of a Venetian blind, which comprises: a slat body and an ink layer printed on the surface of the slat body, wherein the slat body may be made of a PVC (Polyvinyl chloride) foam material or a foam material of mixed PVC and wood flour or any appropriate material, such as a composite material; the ink layer printed on the surface of the slat body may have lustrous finish and various colored patterns so that the entire Venetian blind may have colorful decoration to satisfy the customers.

To enable the objectives, characteristics, and efficacies of the present invention to be more easily understood, the preferred embodiments of the present invention are to be described below in cooperation with the drawings.

### BRIEF DESCRIPTION OF THE DRAWINGS

FIG. 1 is a perspective view showing that the present invention is applied to a Venetian blind according to one preferred embodiment of the present invention.

FIG. 2 is a perspective view of one preferred embodiment of the present invention.

FIG. 3 is a section view of one preferred embodiment of the present invention.

FIG. 4 is a perspective view showing that the present invention is applied to a vertical blind according to one preferred embodiment of the present invention.

### DETAILED DESCRIPTION OF THE PREFERRED EMBODIMENT

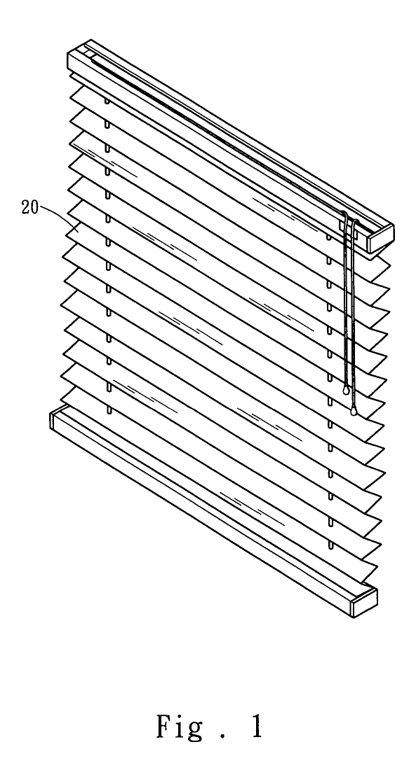

Refer to from FIG. 1 to FIG. 3. The slat structure of a Venetian blind of the present invention comprises: a thin strip-like slat body 10, made of a PVC (Polyvinyl chloride) foam material or a foam material of mixed PVC and wood flour or any appropriate material, such as a composite material; and an ink layer 20, printed to overlay the surface of the slat body 10, and having lustrous finish and various colored patterns to meet the customer's demand.

As the slat body 10 is made of a PVC foam material, which is not only lightweight but also waterproof, the present invention can be extensively applied to bathrooms or used in the windows likely to be showered by rain. In addition to shading strong sunlight, the present invention also may have a decorated appearance to satisfy the customers via the ink layer 20 with the colorful patterns and lustrous finish.

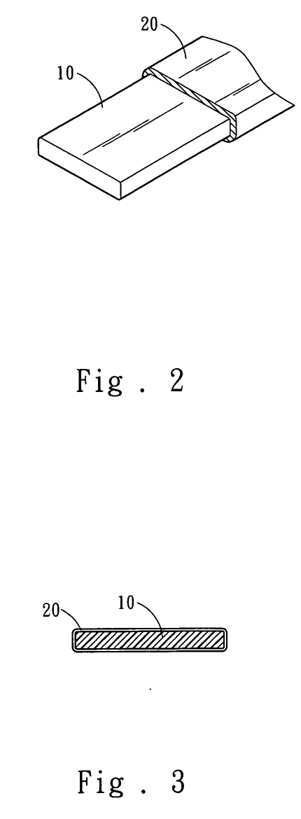

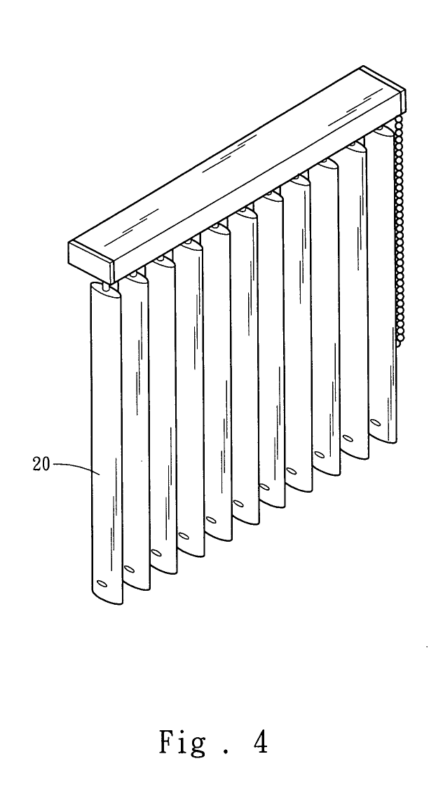

Refer to FIG. 4. The present invention can also apply to vertical blinds. The slat structure of a vertical blind also comprises the slat body 10 and the ink layer 20 printed to overlay the slat body 10, as shown in FIG. 2, wherein the slat body 10 may be made of a PVC foam material, and the ink layer 20 printed on the surface of the slat body 10 may have lustrous finish and various colorful patterns.

The samples, which are fabricated according to the specification and the drawings of the present invention, have been verified to be able to achieve the intended objectives and expected efficacies. The utility of the present invention has been affirmed, and no same or similar product of the present invention has been found in the marketplaces or published documents; the present invention is then filed for the patent.

Although the present invention has been described with the abovementioned embodiments, those are not intended to limit the scope of the present invention, and any equivalent modification and variation according to the spirit of the present invention disclosed herein is to be included within the scope of the claims of the present invention.

What is claimed is:

1. A slat structure of a Venetian blind, comprising: a slat body; and an ink layer, which is printed to overlay said slat body and may have various colors or various colored patterns.
